(19) United States
(12) Patent Application Publication
(10) Pub. No.: US 2022/0172215 A1
(43) Pub. Date: Jun. 2, 2022

(54) FRAUD PREDICTION SERVICE

(71) Applicant: MASTERCARD TECHNOLOGIES CANADA ULC, Vancouver (CA)

(72) Inventors: John Hearty, Vancouver (CA); Jake Madison, Vancouver (CA); Aidan Lawn, Vancouver (CA); Parin Prashant Shah, Vancouver (CA); James Kennedy, Burnaby (CA)

(21) Appl. No.: 17/539,584

(22) Filed: Dec. 1, 2021

Related U.S. Application Data
(60) Provisional application No. 63/120,547, filed on Dec. 2, 2020.

(51) Int. Cl. G06Q 20/40; G06F 16/25; G06N 5/04; G06F 16/2455

(52) U.S. Cl. CPC G06Q 20/4016; G06F 16/254; G06Q 40/02; G06F 16/24552; G06N 5/04

(57) ABSTRACT

Methods and systems of providing fraud prediction services. One method includes receiving a request from a resource provider network and generating a set of features associated with the request. The method also includes accessing a fraud prediction model from a model database and applying the fraud prediction model to the set of features. The method also includes determining, with an electronic processor, a fraud prediction for the request based on the application of the fraud prediction model to the set of features. The method also includes generating and transmitting, with the electronic processor, a response to the request, the response including the fraud prediction.

### RELATED APPLICATIONS

This application claims priority to U.S. Provisional Patent Application No. 63/120,547, filed on Dec. 2, 2020, the entire contents of which are incorporated herein by reference.

### FIELD

Embodiments described herein relate to a fraud prediction service, and, more particularly, to a real-time fraud prediction service.

### BACKGROUND

Financial and e-commerce service providers generally take advantage of machine learning based products or solutions serving the user case of real-time fraud detection. One example solution includes a solution providing real-time fraud detection and online account origination assurance for online credit card applications.

### SUMMARY

Accordingly, there is a need for a tooling or system for developing, deploying, and maintaining machine learning models that can be generalized to serve more use cases and can be used by a larger number of customers than the current solutions support. Therefore, the embodiments described herein include a combination of techniques and functions that provide systems and methods of providing a real-time (or near real-time) fraud prediction service that provides the technical advantage of being more scalable, highly automated, and incorporates additional features than existing solutions. As one example, the embodiments described herein may be scalable to serve approximately 20 million records or events daily. As another technical advantage, the embodiments described herein provide (through the combined techniques and functionality) reduced latency associated with real-time predictions. For example, through implementation of the combined techniques and functionality (as described herein), multiple machine learning models may be applied simultaneously to different subsets of incoming traffic, which may include a high number of transactions per second.

The technical advantages described herein stem from the design and development of a fraud prediction service that can be hosted in a variety of embodiments, including as a cloud service. Accordingly, embodiments described herein offer scalability and redundancy in, for example, the form of duplicated instances. Additionally, the embodiments described herein offers reduced latency via global replication (for example, putting instances closer to end user devices or regional servers that process prediction outputs from the fraud prediction models described herein enables faster turnaround or response time). Furthermore, embodiments described herein reduce latency by delivering the fraud prediction models described herein in the form of lightweight computation functions embedded in deployed services, as described in greater detail herein.

Other aspects of the embodiments described herein will become apparent by consideration of the detailed description and accompanying drawings.

### BRIEF DESCRIPTION OF THE DRAWINGS

FIG. 1 is a block diagram of a system for providing fraud prediction services according to some embodiments.

FIG. 2 is an example communication diagram illustrating communication between components of the system of FIG. 1 according to some embodiments.

FIG. 3 is a block diagram of a fraud prediction service of the system of FIG. 1 according to some embodiments.

FIG. 4 is a block diagram of a feature generation network of the fraud prediction service of FIG. 3 according to some embodiments.

FIG. 5 schematically illustrates a feature generation server of the feature generation network of FIG. 4 according to some embodiments.

FIG. 6 is a block diagram of a model training network of the fraud prediction service of FIG. 3 according to some embodiments.

FIG. 7 is a block diagram of a model deployment network of the fraud prediction service of FIG. 3 according to some embodiments.

FIG. 8 is a block diagram of a model inference network of the fraud prediction service of FIG. 3 according to some embodiments.

FIG. 9 is a block diagram of a model monitoring network of the fraud prediction service of FIG. 3 according to some embodiments.

FIG. 10 is a flow chart of a method of developing and training fraud detection models using the system of FIG. 1 according to some embodiments.

FIG. 11 is an example communication diagram illustrating communication between components of the system of FIG. 1 according to some embodiments.

FIG. 12 is a flow chart of a method of providing fraud prediction services using the system of FIG. 1 according to some embodiments.

Other aspects of the embodiments described herein will become apparent by consideration of the detailed description.

### DETAILED DESCRIPTION OF THE EMBODIMENTS

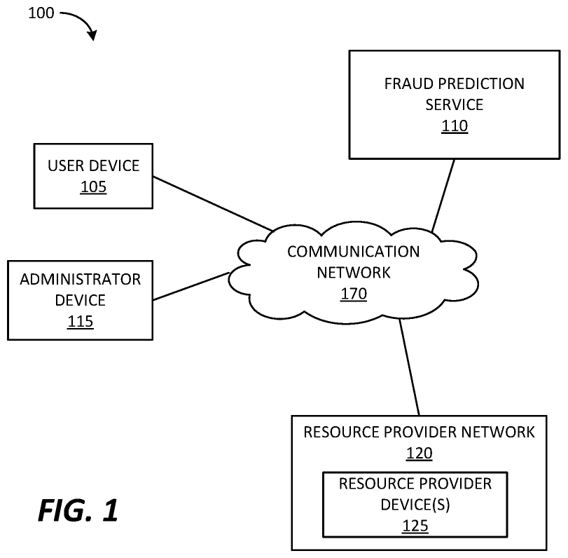

FIG. 1 schematically illustrates a system 100 for providing fraud prediction services according to some embodiments. The system 100 includes a user device 105, a fraud prediction service 110, an administrator device 115, and a resource provider network 120. In some embodiments, the system 100 includes fewer, additional, or different components than illustrated in FIG. 1. For example, the system 100 may include multiple user devices 105, fraud prediction services 110, administrator devices 115, resource provider networks 120, or a combination thereof. Additionally, in some embodiments, one or more components of the system 100 may be distributed among multiple devices, servers, or databases, combined into a single device, server, or database, or a combination thereof

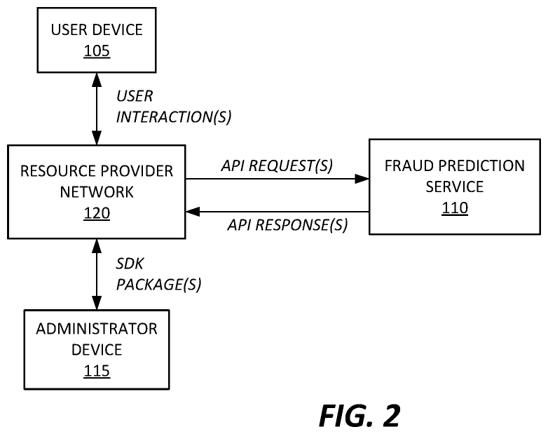

The user device 105, the fraud prediction service 110, the administrator device 115, and the resource provider network 120 communicate over one or more wired or wireless communication networks 170. Portions of the communication network 170 may be implemented using a wide area network (“WAN”), such as the Internet, a local area network (“LAN”), such as a Bluetooth™ network or Wi-Fi, and combinations or derivatives thereof Alternatively or in addition, in some embodiments, components of the system 100 communicate directly as compared to through the communication network 170. Also, in some embodiments, the components of the system 100 communicate through one or more intermediary devices not illustrated in FIG. 1. As one example, FIG. 2 is an example communication diagram illustrating communication between the user device 105, the fraud prediction service 110, the administrator device 115, and the resource provider network 120 according to some embodiments.

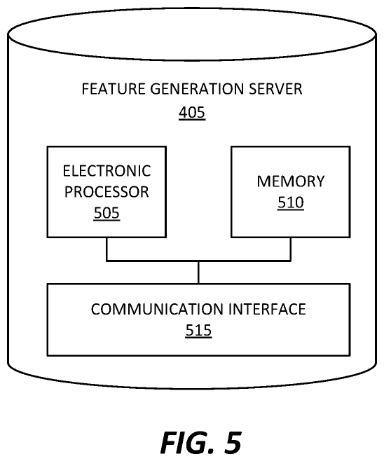

The user device 105 may include one or more desktop computers, laptop computers, tablet computers, terminals, smart telephones, smart televisions, smart wearables, servers, databases, other types of computing devices, or a combination thereof Although not illustrated in FIG. 1, the user device 125 may include an electronic processor (for example, microprocessor, an application-specific integrated circuit (“ASIC”), or another suitable electronic device for processing data), a memory (for example, a non-transitory computer readable medium or another suitable memory device), and a communication interface (as described in greater detail below with respect to FIG. 5). The user device 105 may also include one or more input devices (keyboard, keypad, mouse, joystick, touchscreen, and the like) and one or more output devices (display device, touchscreen, printer, speaker, and the like) that receive input from a user and provide output to a user. A user or customer (for example, an end user, a group of users, an organization, another user entity, or the like) may use the user device 105 to interact with an application or service (such as a cloud-based service) provided or supported by the resource provider network 120, as seen in FIG. 2. Accordingly, in some embodiments, the user device 105 accesses and interacts with the resource provider network 120 through the communication network 170.

As seen in FIG. 1, the resource provider network 120 may include one or more resource provider devices 125. The resource provider devices 125 may include one or more desktop computers, laptop computers, tablet computers, terminals, smart telephones, smart televisions, smart wearables, servers, databases, other types of computing devices, or a combination thereof. Accordingly, in some embodiments, the resource provider network 120 is a computing network, such as a distributed computing network, a cloud computing service, or the like made up of one or more of the resource provider devices 125.

As noted above, the resource provider network 120 may provide an application or service to a user or customer. The resource provider network 120 may be managed by a resource provider, such as a financial institute, an e-commerce entity, or the like. As one example, a financial institute (as the resource provider) may manage the resource provider network 120 to provide a financial service (for example, an online banking service, a financial account management service, or the like). A user may interact with the resource provider network 120 either directly via one or more of the resource provider devices 125 (for example, a resource provider device 125 that is publicly accessible by an end user of the resource provider) or indirectly via one or more intermediary devices (for example, a user device 125). The resource provider network 120 (or one or more resource provider devices 125) may communicate with the fraud prediction service 110, the administrator device 115, another component of the system 100, or a combination thereof as part of providing a cloud-based service to a user (for example, via a user device 125).

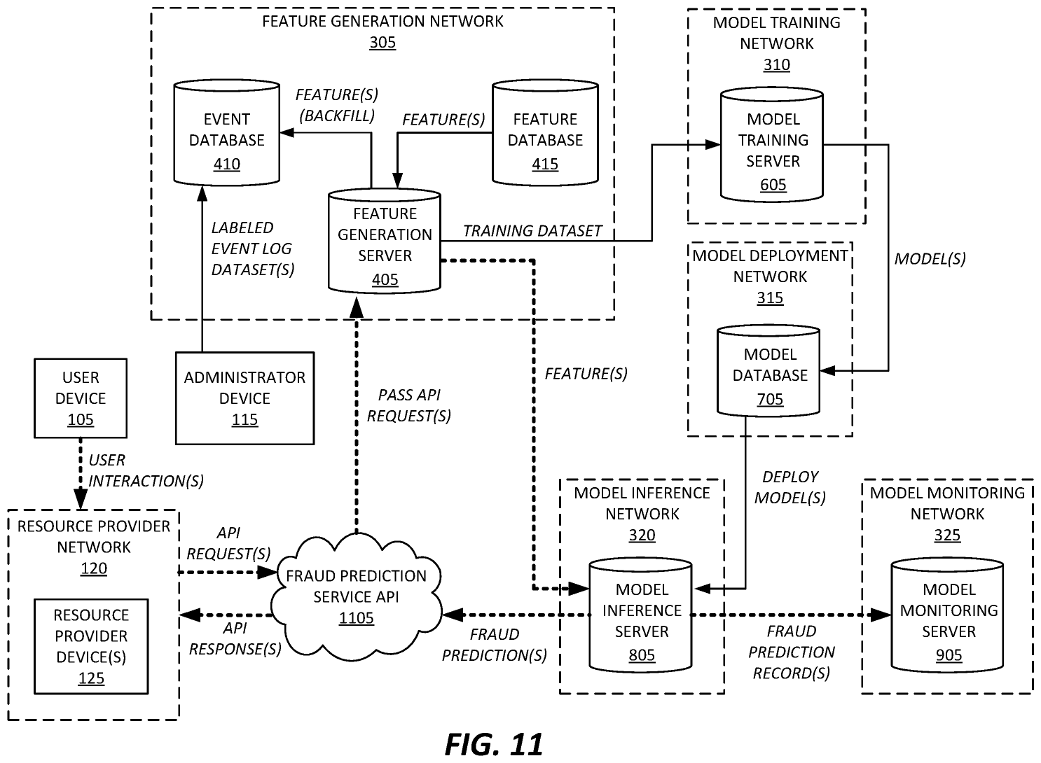

The fraud prediction service 110 is configured to provide or support one or more security or anti-fraud functions, services, or applications, such as fraud detection and monitoring services. For example, the fraud prediction service 110 may support account takeover prevention, fraudulent account creation prevention, and the like. In some embodiments, the fraud prediction service 110 supports multiple security or anti-fraud applications. As described in greater detail below, in some embodiments, the fraud prediction service 110 is a computing network, such as a distributed computing network, a cloud computing service, or the like. In some embodiments, the fraud prediction service 110 communicates with other components of the system 100 via an application programming interface (“API”) (as described in greater detail below with respect to FIG. 11). Accordingly, in some embodiments, as seen in FIG. 2, the fraud prediction service 110 communicates via API requests for data and API responses including the requested data. As one example, the fraud prediction service 110 (via an API of the fraud prediction service 110) receives an API request for a fraud prediction or inference, such as a fraud score. In response to receiving the API request, the fraud prediction service 110 (the API of the fraud prediction service 110) provides an API response including the fraud prediction or inference.

The administrator device 115 may include one or more desktop computers, laptop computers, tablet computers, terminals, smart telephones, smart televisions, smart wearables, servers, databases, other types of computing devices, or a combination thereof Although not illustrated in FIG. 1, the administrator device 115 may include an electronic processor (for example, microprocessor, an ASIC or another suitable electronic device for processing data), a memory (for example, a non-transitory computer readable medium or another suitable memory device), and a communication interface (as described in greater detail below with respect to FIG. 5). The administrator device 115 may also include one or more input devices (keyboard, keypad, mouse, joystick, touchscreen, and the like) and one or more output devices (display device, touchscreen, printer, speaker, and the like) that receive input from a user and provide output to a user.

An administrator may use the administrator device 115 for integrating or implementing the fraud prediction service 110 with the resource provider network 120, such that the resource provider network 120 may leverage the security or anti-fraud services provided by the fraud prediction service 110. Accordingly, an administrator may be a user tasked with providing or supporting the implementation or on-boarding of the fraud prediction service 110 with the resource provider network 120. As one example, the administrator may use the administrator device 115 for generating and providing a software development kit (“SDK”) package to one or more of the resource provider devices 125 of the resource provider network 120, as seen in FIG. 2. In response to implementing the SDK package, the resource provider network 120 may access and leverage the security or anti-fraud services provided by the fraud prediction service 110. As one example, the resource provider network 120 may leverage the fraud prediction service 110 to supplement pre-existing services provided by the resource provider network 120. As another example, the resource provider network 120 may leverage the fraud prediction service 110 as additional or new services provided by the resource provider network 120.

Alternatively or in addition, an administrator may use the administrator device 115 for generating and providing one or more classification labels for event log datasets (for example, a labeled event log dataset as training data). As one example, the administrator may use the administrator device 115 to interact with and review an event log dataset. Based on the administrator's review of the event log dataset, the administrator may provide or assign a classification label for the event log dataset (or a portion thereof). A classification label may include, for example, a binary value, a categorical value represented using string/text, or the like. As one example, a classification label may be a binary label indicating whether a given API request (for example, login request or transaction request) is “fraud” or “not fraud.” Another example may be classifying the requests by different types of fraud (for example, non-fraud, third-party fraud, second-party fraud, first-party fraud, and the like).

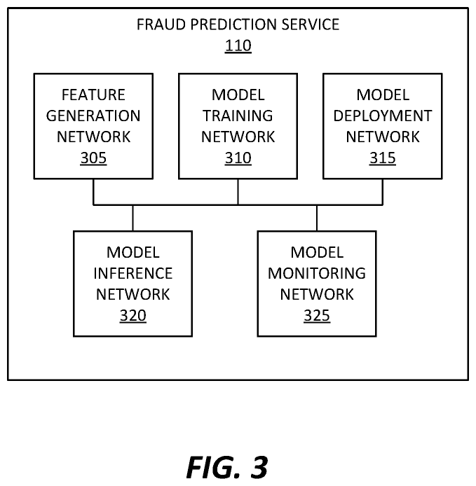

FIG. 3 schematically illustrates the fraud prediction service 110 according to some embodiments. As seen in FIG. 3, the fraud prediction service 110 includes a feature generation network 305, a model training network 310, a model deployment network 315, a model inference network 320, and a model monitoring network 325. In some embodiments, the fraud prediction service 110 includes fewer, additional, or different components (or networks) than illustrated in FIG. 3. Additionally, in some embodiments, one or more components (or networks) of the fraud prediction service 110 may be distributed among multiple networks, combined into a single network, or a combination thereof. As one example, in some embodiments, the model training network 310, the model deployment network 315, and the model inference network 320 (or components thereof) are combined into a single network (for example, as a model network).

The feature generation network 305, the model training network 310, the model deployment network 315, the model inference network 320, and the model monitoring network 325 communicate wirelessly, over one or more communication lines or buses, or a combination thereof. Although FIG. 3 illustrates the feature generation network 305, the model training network 310, the model deployment network 315, the model inference network 320, and the model monitoring network 325 communicating over communication lines or buses, it should be understood that the feature generation network 305, the model training network 310, the model deployment network 315, the model inference network 320, the model monitoring network 325, or a combination thereof may communicate over one or more communication networks (similar to the communication network 170).

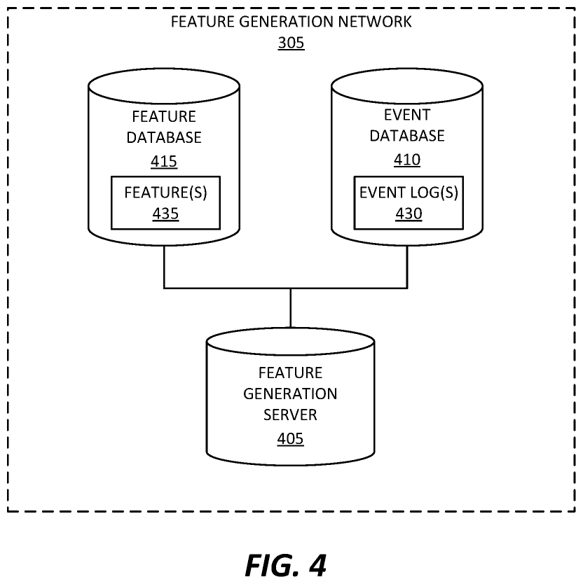

FIG. 4 schematically illustrates the feature generation network 305 according to some embodiments. The feature generation network 305 is configured to leverage event log datasets to generate features or signals for use with fraud detection or prediction models. The feature generation network 305 is configured to support offline model training and real-time (or near real-time) model inference (for example, applying the model to determine a fraud prediction or inference).

In the illustrated example of FIG. 4, the feature generation network 305 includes a feature generation server 405, an event database 410, and a feature database 415. In some embodiments, the feature generation network 305 includes fewer, additional, or different components than illustrated in FIG. 4. For example, the feature generation network 305 may include multiple feature generation servers 405, event databases 410, feature databases 415, or a combination thereof. Additionally, in some embodiments, one or more components of the feature generation network 305 may be distributed among multiple devices, servers, or databases, combined into a single device, server, or database, or a combination thereof. As one example, the event database 410 and the feature database 415 may be combine into a single database.

As illustrated in FIG. 5, the feature generation server 405 includes an electronic processor 505, a memory 510, and a communication interface 515. The electronic processor 505, the memory 510, and the communication interface 515 communicate wirelessly, over one or more communication lines or buses, or a combination thereof. The feature generation server 405 may include additional, fewer, or different components than those illustrated in FIG. 5 in various configurations. The feature generation server 405 may also perform additional functionality other than the functionality described herein. Also, the functionality (or a portion thereof) described herein as being performed by the feature generation server 405 may be distributed among multiple devices, such as multiple servers included in a cloud service environment.

The electronic processor 505 includes a microprocessor, an ASIC, or another suitable electronic device for processing data. The memory 510 includes a non-transitory computer readable medium, such as read-only memory (“ROM”), random access memory (“RAM”) (for example, dynamic RAM (“DRAM”), synchronous DRAM (“SDRAM”), and the like), electrically erasable programmable read-only memory (“EEPROM”), flash memory, a hard disk, a secure digital (“SD”) card, another suitable memory device, or a combination thereof. The electronic processor 505 is configured to access and execute computer-readable instructions (“software”) stored in the memory 510. The software may include firmware, one or more applications, program data, filters, rules, one or more program modules, and other executable instructions. For example, the software may include instructions and associated data for performing a set of functions, including the methods described herein.

The communication interface 515 allows the feature generation server 405 to communicate with devices external to the feature generation server 405. As one example, as illustrated in FIG. 4, the feature generation server 405 may communicate with the event database 410, the feature database 415, or a combination thereof through the communication interface 515. As another example the feature generation server 405 may communicate with one or more components included in another network of the fraud prediction service 110, such as a component of the model training network 310, the model deployment network 315, the model inference network 320, the model monitoring network 325, or a combination thereof, another component of the system 100, or a combination thereof. The communication interface 515 may include a port for receiving a wired connection to an external device (for example, a universal serial bus (“USB”) cable and the like), a transceiver for establishing a wireless connection to an external device (for example, over one or more communication networks 170), or a combination thereof

The feature generation server 405 is configured to generate or determine one or more features (for example, a variable or other characteristic of an event log dataset). A feature may include, for example, a number of unique users, devices, browsers, operating systems, or the like associated with an IP of the request over a specific time-window (for example, last 6 months, 1 day, or the like). Alternatively or in addition, a feature may include, for example, a transaction volume, and its growth, associated for the user associated with the prediction request over a specific time-window, an average, standard deviation, and/or median of the historical risk score for the user associated with the request, a current typing speed of the user, a session duration of the current session, a familiarity of the ISP associated with the IP address in the request, a device reputation score associated with the device used in the request, or a combination thereof.

In some embodiments, the feature generation server 405 may support offline model training (for example, training a model with machine learning without fetching any resources over the Internet). Accordingly, in some embodiments, the feature generation server 405 generates features from batch ETL jobs. A batch ETL job may include, for example, a scheduled batch ETL job for “slow” moving data. As one example, the feature generation server 405 may analyze an event log dataset for a batch ETL job to generate one or more features associated with the batch ETL job (for example, a number of purchases in the last thirty days). After generating features associated with batch ETL jobs, the feature generation server 405 may cache (or store) the generated features in the feature database 415. For example, as seen in FIG. 4, the feature database 415 includes one or more features 435. Accordingly, in some embodiments, the feature database 415 is a database backend used to cache the features 435. Although feature value updates may be delayed depending on how frequently the batch ETL job is run, inference latency may be minimized in a real-time machine learning system (for example, the fraud prediction service 110) by performing batch feature generation as the real-time feature generation may merely be a cache lookup.

Alternatively or in addition, in some embodiments, the feature generation server 405 supports real-time (or near real-time) model inference. In such embodiments, the feature generation server 405 generates features from real-time (or near real-time) ETL jobs (for example, live request data). The feature generation server 405 may generate features from real-time (or near real-time) ETL jobs when the associated data is real-time or fast moving (for example, a number of login attempts within a ten minute time period), the associated data is available within a current API request, or a combination thereof. As one example, the feature generation server 405 may analyze a real-time (or near real-time) ETL job (for example, data associated with a current or live API request) to generate one or more features associated with that real-time ETL job (for example, a number of purchases in the last ten minutes). After generating features associated with real-time (or near real-time) ETL jobs, the feature generation server 405 may provide or transmit the generated features to the model inference network 320 (or a component thereof) for use for fraud prediction or inference, as described in greater detail below. Features generated via near real-time ETL jobs (i.e., for “fast moving data”) may also be cached for successive lookups similar to features generated via batch ETL jobs for “slowing moving” data.

As seen in FIG. 4, the event database 410 includes one or more event logs 430. The event logs 430 may include the raw event log dataset and one or more classification labels associated with each event log dataset. As noted above, the classification labels may be provided by the administrator device 115 (as a labeled event log dataset). Accordingly, in some embodiments, the administrator device 115 interacts with the event database 410 through the communication network 170. In some embodiments, the event logs 430 are used as training datasets or training information, as described in greater detail below.

Accordingly, the feature generation server 405 is configured to generate or determine features or additional variables for or from one or more event log datasets (associated with either real-time ETL jobs or batch ETL jobs). An event log dataset may include, for example, a request ID, a request time, a user ID, a device address, an IP address, an Internet service provider, a device characteristic (for example, an operating system, a browser, or the like), an IP characteristic (for example, a time zone, whether the IP is a proxy, or the like), an input profile record (for example, a custom data element generated via a passive biometric technology), and the like. In some embodiments, the feature generation server 405 backfills features to one or more of the event logs 430. Accordingly, in some embodiments, the feature generation server 405 performs backfilling in the event of a failure, where features for events starting from a known checkpoint may need to be back filled. A trigger for backfilling may be driven by a manual user trigger. As one example, a user (i.e., a data scientist) may want to backfill a feature f starting from date d. Then, the user manually triggers a feature generation job, which would then execute the backfill since the date d. The backfill is used to typically fetch features for a model training task or to ensure that features are available for all entities (such as for all users) during model inference. Accordingly, in some embodiments, the feature generation server 405 allows for backfilling of features to generate a training dataset for offline model training. In such embodiments, a configurable date-range parameter may be supplied at run-time (via, for example, the administrator device 120). The configurable date-range may specify the subset of data on which the feature generation server 405 generates features.

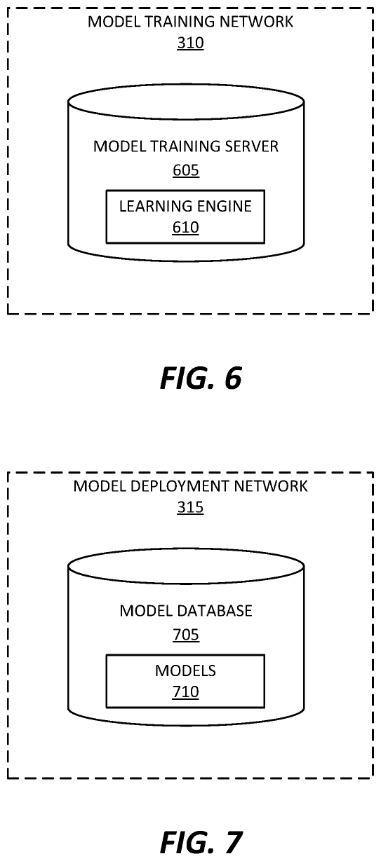

FIG. 6 schematically illustrates the model training network 310 according to some embodiments. The model training network 310 is configured to use a labeled training dataset (prepared or generated by the feature generation network 305) for training a model (for example, a supervised classification model), tuning the model, and outputting model artifacts to a storage service (for example, the model deployment network 315). Alternatively or in addition, in some embodiments, the model training network 310 may perform additional functions, such as sampling (for example, to select a set a records to use for model training), hyperparameter optimization (“HPO”) (for example, to identify optimal model performance that maximizes model performance), feature selection and model performance evaluation (for example, to identify features that have the largest contribution in terms of driving the model performance), and the like. In some embodiments, the functionality of the model training network 310 may be triggered manually. However, in other embodiments, the functionality performed by the model training network 310 may be triggered in response to receiving a set of generated features from the feature generation network 305. Additionally, in some embodiments, the functionality performed by the model training network 310 may be performed independently of any single compute resource. In such embodiments, the model training network 310 may be able to leverage horizontal scaling, vertical scaling, or a combination thereof. Additionally, in some embodiments, the model training performed by the model training network 310 may be automated via a set of pre-defined steps (for example, pre-defined steps specified in a custom model training library of the model training network 310).

In the illustrated example, the model training network 310 includes a model training server 605. In some embodiments, the model training network 310 includes fewer, additional, or different components than illustrated in FIG. 6. For example, the model training network 310 may include multiple model training servers 605. Additionally, in some embodiments, one or more components of the model training network 310 may be distributed among multiple devices, servers, or databases.

The model training server 605 is configured to train or develop one or more models for making fraud predictions or inferences. As seen in FIG. 6, the model training server 605 may store (in a memory of the model training server 605) a learning engine 610. In some embodiments, the learning engine 610 develops a model using one or more machine learning functions. Machine learning functions are generally functions that allow a computer application to learn without being explicitly programmed. In particular, a computer application performing machine learning functions (sometimes referred to as a learning engine) is configured to develop an algorithm based on training data or training information. For example, to perform supervised learning, the training data includes example inputs and corresponding desired (for example, actual) outputs, and the learning engine progressively develops a model that maps inputs to the outputs included in the training data. Machine learning may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. Using one or more of these approaches, a computer program may ingest, parse, and understand data and progressively refine models for data analytics.

Accordingly, the learning engine 610 (as executed by an electronic processor of the model training server 605) may perform machine learning using training datasets to develop a model that maps one or more features to a classification (for example, a fraud prediction or score). The training dataset may include, for example, features generated for event log datasets and their associated classifications (for example, the event logs 430 stored in the event database 410 of the feature generation network 305). For example, the learning engine 610 may identify one or more unique characteristics or trends of the features and develop a model that maps the one or more unique characteristics or trends to a particular classification. As one example, a feature may be a user's typing speed calculated as average words per minute. When the value of this feature is high, a corresponding classification label for such a record is fraud. Following this example, the model may learn that whenever the typing speed is high, it is indicative of fraud behavior. In some embodiments, a model looks at interactions between multiple features to make such inferences. Accordingly, when a subsequent set of features for an event log dataset is received, the developed model may be used to determine a classification for that subsequent set of features. In other words, the model, once trained, analyzes a set of features to identify one or more characteristics or treads in the set of features and assign the event log dataset a classification based on any detected characteristics or trends.

FIG. 7 schematically illustrates the model deployment network 315 according to some embodiments. The model deployment network 315 is configured to track model training experiments (for example, for transparency and ease of reproducibility). In some embodiments, the model deployment network 315 tracks model attributes, such as model performance metrics, configurations, trained model artifacts, experiment version, model author, and the like. In some embodiments, the model deployment network 315 may generate and provide a user interface for viewing experiment metrics, querying historical model experiment runs, managing model versions, selecting model versions, and the like. Alternatively or in addition, the model deployment network 315 may determine which model experiments to deploy for real-time inference requests. Accordingly, the model deployment network 315 may manage deployment or access of the trained models 710.

In the illustrated example, the model deployment network 315 includes a model database 705. In some embodiments, the model deployment network 315 includes fewer, additional, or different components than illustrated in FIG. 7. For example, the model deployment network 315 may include multiple model databases 705. Additionally, in some embodiments, one or more components of the model deployment network 315 may be distributed among multiple devices, servers, or databases. As seen in FIG. 7, the model database 705 stores one or more models 710. In some embodiments, the model database 705 receives the models 710 from the model training network (for example, the model training server 605).

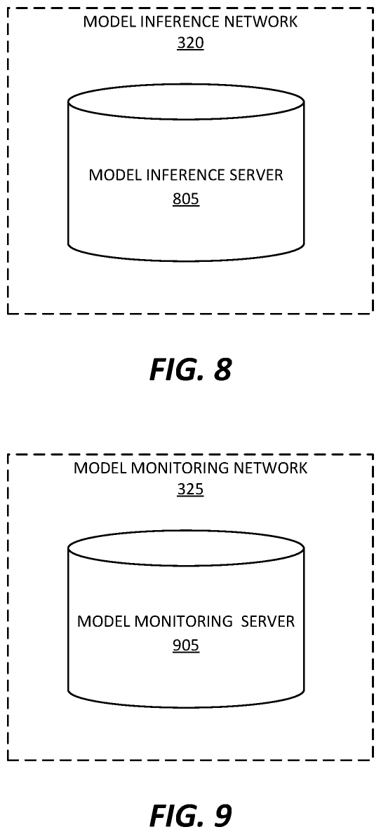

FIG. 8 schematically illustrates the model inference network 320 according to some embodiments. In the illustrated example, the model inference network 320 includes a model inference server 805. In some embodiments, the model inference network 320 includes fewer, additional, or different components than illustrated in FIG. 8. For example, the model inference network 320 may include multiple model inference servers 805. Additionally, in some embodiments, one or more components of the model inference network 320 may be distributed among multiple devices, servers, or databases.

The model inference server 805 is configured to determine a fraud prediction or inference (such as a fraud score) for a set of features using one or more models (for example, the models 710). As described in greater detail below, the model inference server 805 may receive a set of generated features from the feature generation server 405 and access a model 710 from the model database 705. The model inference server 805 may then apply the model 710 to the set of generated features to determine a fraud prediction or inference for the generated features (or the event log dataset associated with the generated features).

In some embodiments, the model inference server 805 returns real-time predictions with a latency of less then or equal to approximately 100 ms, where the latency calculation also includes the time taken to generate features prior to performing the inference or prediction. In some embodiments, the model inference server 805 is scalable for handling a high number of transactions per second. Alternatively or in addition, the model inference server 805 services (or deploys) multiple models simultaneously to different subsets of incoming traffic. According to such embodiments, the model inference server 805 may be independent of any single resource and may be scalable horizontally in response to increased traffic. Accordingly, embodiments described herein may provide the technical advantage of reducing latency by delivering lightweight computation functions embedded in deployed services. Additionally, in some embodiments, the model inference server 805 provides a production environment and a staging-like environment. The provision of both environments enables testing of developed models in staging prior to promoting them or providing them to a quality assurance and/or production environment for deployment.

FIG. 9 schematically illustrates the model monitoring network 325 according to some embodiments. In the illustrated example, the model monitoring network 325 includes a model monitoring server 905. In some embodiments, the model monitoring network 325 includes fewer, additional, or different components than illustrated in FIG. 9. For example, the model monitoring network 325 may include multiple model monitoring servers 905. Additionally, in some embodiments, one or more components of the model monitoring network 325 may be distributed among multiple devices, servers, or databases.

The model monitoring server 905 is configured to monitor or determine a performance of one or more of the models 710 deployed as part of determining a fraud prediction or inference for a set of generated features. The model monitoring server 905 may also generate and provide a visual dashboard (for example, a web-based user interface). The visual dashboard may include, for example, a statistical performance metric for a model 710, an alert when a model 710 is degrading (for example, when feature drift is detected), or the like. In some embodiments, the model monitoring server 905 transmits the visual dashboard to a remote device for display. As one example, the model monitoring server 905 may transmit the visual dashboard to the administrator device 115 for display to an administrator via a display device of the administrator device 115. As another example, the model monitoring server 905 may transmit the visual dashboard to the resource provider network 120 for display via one or more of the resource provider devices 125.

Although not illustrated, the model training server 605, the model database 705, the model inference server 805, the model monitoring server 905, or a combination thereof may include similar components as the feature generation server 405, such as electronic processor (for example, a microprocessor, an ASIC, or another suitable electronic device), a memory (for example, a non-transitory, computer-readable storage medium), a communication interface, such as a transceiver, for communicating over the communication network 170 and, optionally, one or more additional communication networks or connections, and one or more human machine interfaces. The model training server 605, the model database 705, the model inference server 805, the model monitoring server 905, or a combination thereof may also perform additional functionality other than the functionality described herein. Also, the functionality described herein as being performed by the model training server 605, the model database 705, the model inference server 805, the model monitoring server 905, or a combination thereof may be distributed among multiple servers or devices (for example, as part of a cloud service or cloud-computing environment).

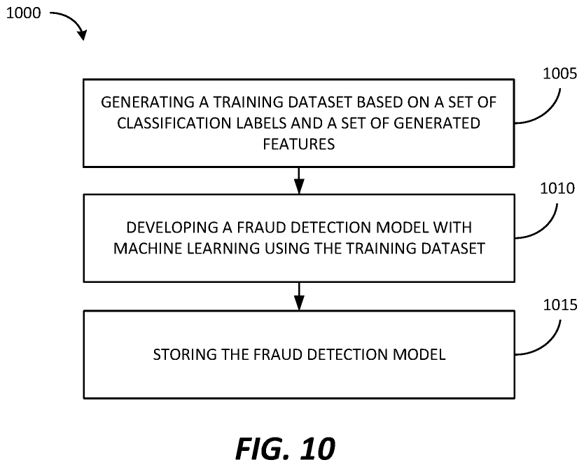

FIG. 10 illustrates a method 1000 for developing and training fraud detection models according to some embodiments. In some embodiments, the method 1000 is performed as an offline model training process. The method 1000 is described herein with reference to FIG. 11. FIG. 11 is an example communication diagram 1100 illustrating the communication between one or more components as part of performing the method 1000 according to some embodiments.

As seen in FIG. 10, the method 1000 includes generating a training dataset based on a set of classification labels and a set of generated features (at block 1005). In some embodiments, the training dataset is a labeled event log dataset received from the administrator device 115. As seen in FIG. 11, the labeled event log dataset may be received from the administrator device 115. As also seen in FIG. 11, the event database 410 may receive and store the labeled event log dataset. As noted above, an administrator may use the administrator device 115 for generating and providing one or more classification labels for event log dataset (for example, the labeled event log dataset). As one example, the administrator may use the administrator device 115 to interact with and review an event log dataset. Based on the administrator's review of the event log dataset, the administrator may provide or assign a classification label for the event log dataset.

After generating the training dataset (at block 1005), the method 1000 includes developing a fraud detection model with machine learning using the training dataset (at block 1010). As one example, as seen in FIG. 11, the feature generation network 305 (for example, the feature generation server 405) transmits the training dataset to the model training network 310 (for example, the model training server 605). Upon receiving the training dataset, the model training server 605 (the learning engine 610 as executed by the electronic processor of the model training server 605) performs machine learning using the training dataset to develop a fraud detection model that maps one or more features to a classification (for example, a fraud prediction or score), as described in greater detail above.

The model training server 605 may transmit or provide the fraud detection model to the model deployment network 315 (for example, the model database 705). For example, as seen in FIG. 11, the model training server 605 transmits the fraud detection model to the model database 705. The model database 705 may store the fraud detection model in response to receiving the fraud detection model from the model training server 605 (at block 1015).

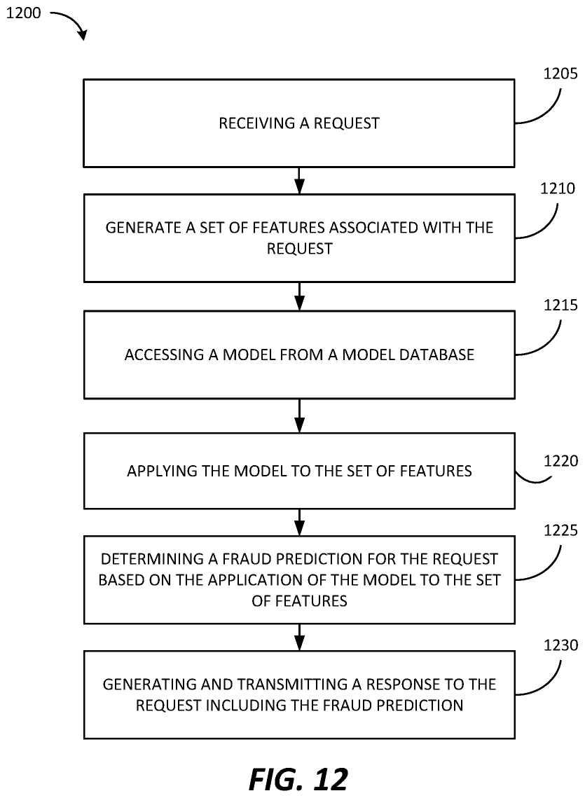

FIG. 12 illustrates a method 1200 for providing fraud prediction services according to some embodiments. In some embodiments, the method 1200 is performed as a real-time (or near real-time) model inference or application process. The method 1200 is described herein with reference to FIG. 11.

As seen in FIG. 12, the method 1200 includes receiving a request (at block 1205). As seen in FIG. 11 and described above, a user or customer may use the user device 105 to interact with an application or service provided or supported by the resource provider network 120 (for example, an online banking service, a financial account management service, or the like). In response to the user interactions, the resource provider network 120 (or a resource provider device 125 thereof) may communicate via an API of the fraud prediction service 110 (illustrated in FIG. 11 as a fraud prediction service API 1105). Accordingly, in some embodiments, as seen in FIG. 11, the resource provider network 120 may communicate with the fraud prediction service 110 via API requests for data and API responses including the requested data. As one example, the fraud prediction service 110 (via an API of the fraud prediction service 110) receives an API request for a fraud prediction, such as a fraud score. In some embodiments, the model inference server 805 exposes the fraud prediction service API 1105 as a RESTful API through which the resource provider network 120 may request real-time fraud predictions.

In response to receiving the request (for example, an API request from the resource provider network 120), the request, data associated with the request (for example, event log data), or a combination thereof may be transmitted or forwarded to the feature generation server 405. The feature generation server 405 may analyze the request, the data associated with the request, or a combination thereof and generate (or determine) features associated with the request, the data associated with the request, or a combination thereof (at block 1210). As seen in FIG. 11, the features may be passed or forwarded to the model inference network 320 (for example, the model inference server 805).

After features are generated for the request, the model inference server 805 then accesses one or more models 710 from the model database 705 (at block 1215). The model inference server 805 may apply the one or more models 710 accessed from the model database 705 to the set of features (at block 1220). Accordingly, in some embodiments, the model inference server 805 receives a set of features from the feature generation server 405 and accesses a model 710 from the model database 705. The model inference server 805 may then apply the model 710 to the set of features in order to determine a fraud prediction or inference. Accordingly, in some embodiments, the model inference server 805 determines a fraud prediction of the request based on the application of the model 710 to the set of features (at block 1225).

The model inference server 805 may then generate and transmit a response (an API response) including the fraud prediction (at block 1230). As seen in FIG. 11, the model inference server 805 may return a fraud prediction (or fraud score) via the fraud prediction service API 1105 (as an API response) to the resource provider network 120.

Alternatively or in addition, in some embodiments, the model inference server 805 generates and transmits a fraud prediction record to the model monitoring server 905, as seen in FIG. 11. The fraud prediction record may include, for example, a fraud prediction, a fraud score, a set of features, or the like associated with the API request. In response to receiving the fraud prediction record, the model monitoring server 905 may analyze the fraud prediction record to monitor the model 710. In some embodiments, the model monitoring server 905 manages and provides a visual dashboard or user interface, such as a web-based dashboard, for monitoring and visualizing performance of deployed models. As one example, the visual dashboard provides (or displays) statistical model performance metrics, such as prediction score distributions, feature distributions, and the like. The model monitoring server 905 may compare live feature distributions (for example, feature distributions from live or real-time API requests) against feature distributions of the training dataset in order to monitor feature drift. For comparison, the model monitoring server 905 may select a training dataset by selecting an appropriate experiment via an integration with an experiment tracking library of the model deployment network 315. In some embodiments, the model monitoring server 905 may generate and provide an alert or warning when model performances degrade, such as in case of a feature drift. Alternatively or in addition, the visual dashboard may include computational performance metrics of the real-time feature generation service and model hosting service, such as latency, throughput, and the like.

It is to be understood that the embodiments described herein are not limited in application to the details of construction and the arrangement of components set forth in the following description or illustrated in the accompanying drawings. The embodiments are capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and may include electrical connections or couplings, whether direct or indirect. Also, electronic communications and notifications may be performed using any known means including direct connections, wireless connections, etc.

A plurality of hardware and software based devices, as well as a plurality of different structural components may be utilized to implement the embodiments described herein. In addition, embodiments described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments described herein may be implemented in software (for example, stored on non-transitory computer-readable medium) executable by one or more processors. As such, it should be noted that a plurality of hardware and software based devices, as well as a plurality of different structural components, may be utilized to implement the embodiments described herein. For example, “mobile device,” “computing device,” and “server” as described in the specification may include one or more electronic processors, one or more memory modules including non-transitory computer-readable medium, one or more input/output interfaces, and various connections (for example, a system bus) connecting the components.

It should be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, the embodiments described herein provide, among other things, methods and systems for providing a fraud prediction service. Various features and advantages of the invention are set forth in the following claims.

What is claimed is:

1. A method of providing fraud prediction services, the method comprising:
receiving a request from a resource provider network;
generating a set of features associated with the request;
accessing a fraud prediction model from a model database;
applying the fraud prediction model to the set of features;
determining, with an electronic processor, a fraud prediction for the request based on the application of the fraud prediction model to the set of features; and
generating and transmitting, with the electronic processor, a response to the request, the response including the fraud prediction.

2. The method of claim 1, further comprising:
generating a fraud prediction record; and
transmitting the fraud prediction record to a model monitoring service, wherein the model monitoring service is configured to determine a performance metric associated with the fraud prediction model.

3. The method of claim 2, wherein determining the performance metric includes determining at least one selected from a group consisting of a prediction score distribution and a feature distribution.

4. The method of claim 2, further comprising:
comparing, via the model monitoring service, a live feature distribution against a feature distribution of a training dataset associated with the fraud prediction model, and generating an alert when the comparison indicates feature drift.

5. The method of claim 1, further comprising:
generating a training dataset based on a set of classification labels and a set of generated features;
developing the fraud detection model with machine learning using the training dataset; and
storing the fraud detection model in the model database.

6. The method of claim 5, further comprising:
generating the set of generated features, wherein generating the set of generated features includes analyzing an event log dataset for a batch ETL job to generate the set of generated features.

7. The method of claim 6, further comprising:
caching the set of generated features in a feature database backend,
wherein generating the set of features associated with the request includes performing a cache lookup from the feature database backend.

8. The method of claim 5, wherein developing the fraud detection model includes developing the fraud detection model using offline training of the fraud detection model with machine learning using the training dataset.

9. The method of claim 5, wherein at least one classification label included in the set of classification labels is a binary label.

10. The method of claim 5, wherein at least one classification label included in the set of classification labels includes a categorical label represented by text.

11. The method of claim 5, wherein the set of classification labels includes a label of at least one selected from a group consisting of a non-fraud label, a third-party fraud label, a second-party fraud label, and a first-party fraud label.

12. The method of claim 1, further comprising:
transmitting a software development kit (SDK) package to the resource provider network, wherein the request is received from the resource provider network after the resource provider network implements the SDK package.

13. The method of claim 1, wherein receiving the request includes receiving a request associated with an online account origination.

14. A system of providing fraud prediction services, the system comprising:
a memory configured to store instructions; and
an electronic processor coupled to the memory, wherein the electronic processor, through execution of the instructions stored in the memory, is configured to:
receive a request from a resource provider network,
generate a set of features associated with the request,
access a fraud prediction model from a model database,
apply the fraud prediction model to the set of features,
determine a fraud prediction for the request based on the application of the fraud prediction model to the set of features, and
generate and transmit a response to the request, the response including the fraud prediction.

15. The system of claim 14, wherein the set of features includes at least one feature including a transaction volume growth over a time-window for a user associated with the request.

16. The system of claim 14, wherein the set of features includes at least one feature including at least one selected from a group consisting of an average, a standard deviation, or a median of a historical risk score for a user associated with the request.

17. The system of claim 14, wherein the set of features includes at least one selected from a group consisting of a typing speed of a user associated with the request, a session duration of a user associated with the request, and a device reputation score for a device associated with the request.

18. The system of claim 14, wherein the electronic processor is further configured to
generate a training dataset based on a set of classification labels and a set of generated features,
develop the fraud detection model with machine learning using the training dataset, and
store the fraud detection model in the model database.

19. The system of claim 18, wherein the electronic processor develops the fraud detection model using offline training of the fraud detection model with machine learning using the training dataset.

20. A non-transitory computer readable medium storing instructions that, when executed by an electronic processor, perform a set of functions, the set of functions comprising:
receiving a request from a resource provider network;
generating a set of features associated with the request;
accessing a fraud prediction model from a model database, wherein the fraud detection model is developed using offline training of the fraud detection model with machine learning using a training dataset;
applying the fraud prediction model to the set of features;
determining, with an electronic processor, a fraud prediction for the request based on the application of the fraud prediction model to the set of features; and
generating and transmitting, with the electronic processor, a response to the request, the response including the fraud prediction.
